(19) United States
(12) Patent Application Publication
(10) Pub. No.: US 2023/0084178 A1
(43) Pub. Date: Mar. 16, 2023

(54) METHODS AND SYSTEMS FOR IMPROVING THE EFFICIENCIES OF POWER AND OTHER INDUSTRIAL PROCESS PLANTS

(71) Applicant: Joseph Peter MACEDA, New York, NY (US)

(72) Inventor: Joseph Peter MACEDA, New York, NY (US)

(21) Appl. No.: 17/760,192

(22) PCT Filed: Feb. 10, 2021
(86) PCT No.: PCT/US2021/010002

§ 371 Date: Aug. 5, 2022

Related U.S. Application Data
(60) Provisional application No. 62/972,246, filed on Feb. 10, 2020.

(51) Int. Cl. B01D 53/14; B01D 53/34; B01D 53/62; B01D 53/96; H01M 8/14; H01M 8/2455

(52) U.S. Cl. CPC B01D 53/1418; B01D 53/343; B01D 53/62; B01D 53/96; H01M 8/143; H01M 8/2455; B01D 2251/304; B01D 2251/604; B01D 2257/504

(57) ABSTRACT

This present invention describes methods and systems for integrating liquid-phase, electrochemical and chemical processes into power generation, petrochemical, metal, cement and other industrial process plants, in such a manner as to capture and recycle all input carbon into cost-competitive hydrogen, oxygen and hydrocarbons. These integrated systems will recover internally generated losses in chemical potential (AG Gibbs Free or Available Energy) as well as waste heat (ΔH—Enthalpy), and sometimes electricity, to assist in driving these electrochemical and chemical processes, which will increase the total useful output of the process plants, thereby increasing thermal, carbon and economic efficiency.

### CROSS-REFERENCE TO RELATED APPLICATIONS

This application claims the benefit of the filing dates of U.S. Provisional Patent Applications No. 62/972,323 filed Feb. 10, 2020 and No. 62/972,531 filed Feb. 12, 2020, the disclosures of which is hereby incorporated herein by reference.

### FIELD OF INVENTION

The present invention relates to the field of industrial process plants such as power generation, steel production, aluminum production, cement production, paper production, petrochemical production et.al., all of which use fossil fuels, raw materials and electrical energy to produce desired outputs. This invention describes the integration of novel, liquid-phase, electrochemical and chemical processes, originally developed by Dr Patrick Grimes (Grimes Processes), that use internally generated waste heat (ΔH), exothermic changes in chemical potential (ΔG) and/or electricity to synthesize cost-competitive hydrogen, high-grade hydrocarbons and oxygen from the input fossil carbon, electricity, water and/or atmospheric carbon dioxide. This capture, integration and recycling of currently “wasted” energy will improve the thermal, carbon and economic efficiencies of industrial process or power plants.

### BACKGROUND OF THE INVENTION

According to the International Energy Agency (IEA), in 2018 81% of the total energy supply worldwide was provided by fossil fuels (coal, natural gas and oil). The thermal and thermochemical conversion of these resources into energy and other useful products created just over 33.5 billion tons (Gigatonnes or Gt) of carbon dioxide emissions (CO₂)emissions. The Energy Sector alone contributed 15.6 Gt of this total (46.5%) while the Industrial and Transport Sectors emitted 6.2 Gt & B.3Gt respectively (18.4% and 24.6%). Electricity alone accounts for 1.9 Gt (19.3%). By energy source, coal contributes 14.7 Gt (44.1% of the total) with oil contributing 11.4 Gt (34.1%) and natural gas 7.1 Gt (21.2%).

Virtually all of these emissions are created because most of these current processes that convert chemical reactants into commercial synthesis products are thermally driven. Reactants are mixed in reactors and are heated to specific temperatures until reactor output is of sufficient quantity or purity to meet commercial product specifications. Often, adding catalysts inside the reactor can accelerate these thermally driven processes. Reduction in processing time typically means a reduction in cost and a large volume of product ready for the market. Typically, thermally driven processes need to have the process heating temperatures much higher than the theoretical reaction temperature to ensure that product output meets minimum quality level at all times. The process temperature needs to be in excess to account for heat loss from the reactor to the atmosphere, depletion of the catalysts reactivity over operating time and heat loss through the exiting products, such as steam or exhaust gases.

Often the products produced from thermally driven processes are a mixture of desired product and unwanted by-products. In some processes the ratio of wanted products versus unwanted by-products is as high as 50%. Unwanted chemical reactions may occur in parallel with the main reaction because of the overheated raw materials. These reactions may take some of the thermal energy input leaving the desired reaction with insufficient thermal energy supply. The product stream from the reactor needs extra steps in order to separate or purify the desired product from the unwanted by-products. Sometimes special measures must be taken for blocking or slowing down other reactions that occur in parallel with the desired process in order to meet the specifications for a salable product. The separation process step or steps usually require the additional input of thermal heat in order to facilitate the process. Also, the purification step may require an additional input of thermal heat. The separation and purification steps may also produce an additional amount of exhaust heat or other types of energy.

Today's thermally driven processes that produce marketable products for the chemical and energy industry use systems made up of reactors, separators and purification subsystems. Accounting for the excess heat energy input required to operate each subsystem compared to the collective amount of waste heat energy exhausted from each subsystem, shows an energy inefficiency.

Energy efficiency is a vital component of the nation's energy strategy. Efficiency is an increasing need in today's world of diminishing energy supply, alternative fuels, climate change and pollution. Improvements in efficiency will help mitigate some of these concerns. The majority of processes used in the energy and chemical sectors are thermally driven. For conventional thermal processes the thermodynamic energy efficiency is defined as;

$$Energy Efficiency = \frac{Useful Energy Output}{Energy Input}$$

or in the case of a chemically fueled heat engine, it is compared to the efficiency of a Carnot cycle having the same temperature limits;

$$Energy Efficiency = \frac{Work Out}{Heat of Combustion of Fuel Input} .$$

We tend to think of chemically fueled heat engines in terms of an equivalent closed cycle with the heat supplied from external combustion of fuel. This view leads to acceptance of the efficiency of an equivalent Carnot engine as the standard, against which the design is to be judged. The maximum theoretical work is then calculated from the heat of combustion of the fuel (H_{C}) and the temperature limits of the work producing subsystem. This expression for maximum work (W) is:

W=H_{C}(T₁−T₂)/T₁ (1)

This invention operates from distinctly different viewpoints, based upon the Gibbs free energy equation. One of these is found in the design and analysis of chemically fueled heat engines: the acceptance of an equivalent closed cycle system as the basis for evaluation. We have tended to overlook the fact that Carnot efficiency is not defined for an open cycle.

It also shows that the theoretical efficiency of such an engine is limited by the chemical potential of the fuel with a secondary dependency on the temperature limits. In contrast to this Carnot view, the Gibbs expression for maximum work is based upon the change in the Enthalpy (H), Entropy (S) and Temperature (T) of the reactants and products. The maximum theoretical work is equal to the negative of the change in the Gibbs Function (G), sometimes referred to as the Thermodynamic-Potential or as the Gibbs Free Energy.

W=−ΔG=ΔT*S−ΔH (2)

There is no contradiction between these expressions. They refer to the systems with different constraints. The Gibbs energy refers to the reversible conversion of potential energy to work. The Carnot expression refers to the reversible conversion of thermal energy (sensible heat) to work, assuming that all of the heat combustion of the fuel is supplied to the prime mover. Since sensible heat is a form of potential energy, the Gibbs expression must be equivalent to the Carnot expression for the same system.

Since the Carnot engine is a closed cycle system, there are no net changes in the Enthalpy, Entropy, or Temperature. Thus the sum of the T*S products must be zero

T*ΔS−S*ΔT=0 (3)

Recognizing that T*ΔS is a heat transfer term and S*ΔT is a work transfer term, we can derive the Carnot expression, the net work produced, must be equal to the net heat added. Thus the maximum work is given as:

W=T₁*ΔS₁−T₀*ΔS₀ (4)

We have said, in effect that: ΔS₁−ΔS₀. We also assumed that the heat input is equal to the heat of combustion of the fuel. Eliminating AS from the expression above yields the Carnot expression, as a special case of the Gibbs expression.

This invention presents concepts for integrating this chemical recovery of waste heat into existing processes. It shows that the maximum theoretical efficiency of converting chemical energy to work is not limited to the Carnot efficiency of the heat engine subsystem. A partial dependency upon the Carnot efficiency is established for the maximum efficiency of a real chemically fueled heat engine. The thermodynamic analysis of chemically fueled engines is, more logically, based upon the work of J. Willard Gibbs. The Gibbs function decrease expresses the maximum work capability of the fuel oxidation energy conversion system.

The chemical and energy industries need more energy efficient processes to generate desired products and minimizing or eliminating waste produced. These waste products represent lost profit opportunities, in the case of unrecovered molecules and damage to the environment, such as the case of Greenhouse Gas emissions. As all studies have indicated, the reduction of these emissions is critical to the future economic health of all of the population of the world and the physical health of much of it.

In addition to thermal efficiency, this invention addresses the issue of carbon efficiency. Until recently, there was virtually no concern over this issue. All carbon on earth started as atmospheric carbon dioxide. For billions of years, nature removed carbon from the atmosphere through a process called weathering, where it combined it with water and converted it into carbonate minerals. This permanently sequestered 99.9% of the total and left the rest as coal, oil, natural gas, hydrates, plants animals and atmospheric CO₂, These atmospheric CO₂ levels have remained relatively constant, cycling within a narrow band with the peak at just under 300 ppm for the last few million years. Starting in the early 19th Century, humans began exhuming fossil carbon, combusting it and venting the resultant gases into the atmosphere. Based on the accepted rate of weathering, human additions exceeded natural removals around the turn of the 20th Century and the ongoing excess adds up to the additional 100+ ppm that concern us today.

Now that awareness of this problem has grown, a new unit has been created to measure it, which is defined as;

$$Carbon Intensity ( CI ) = \frac{Grams of Carbon {Dioxide}_{( equivalents )}}{MJ of Energy Output}$$

All of the systems considered by this invention show significant reduction of these CI numbers and in many cases, total elimination or a shift into negativity.

A final element considered by this invention is Economic Efficiency. There are a multitude of ways of measuring this including, Return on Capital Invested (ROI), Internal Rate of Return (IRR), Earnings Before Income Tax, Depreciation and Amortization (EBITDA), etc. We will show the relationship between these different efficiencies and how, unlike competing approaches, increasing the first, will reduce the second while increasing the third. Current carbon emission can actually become a new, commercially valuable resource.

This is most relevant in the area of liquid fuels. Currently, modern society is heavily dependent on fossil hydrocarbons as its primary source of energy. Petroleum dominates the transportation market while coal and natural gas dominate the power generation market. This dependence is becoming progressively less sustainable from the economic, political and environmental points of view. Anthropogenic carbon dioxide emissions are continuing to increase along with energy demand and escalating costs. As one of the greenhouse gases (GHGs), carbon dioxide concentration is steadily growing in the atmosphere. To keep GHGs at a manageable level, large deceases in carbon dioxide (CO₂)emissions will be required. Major efforts are underway to try to find methods: to re-use emitted carbon dioxide in industrial processes; to convert carbon dioxide into valuable fuel, chemicals or materials; to capture and sequester carbon dioxide; and to develop zero- and low carbon-emission technologies to increase energy conversion efficiency. These efforts have yet to produce significant or economical methods of re-using carbon dioxide in order to meet the global goals of GHG of stabilization and reduction.

Various carbon capture, utilization and storage (CCUS) are being developed and tested. These range from injection underground, through mineralization to the combination of gaseous CO2 with renewable hydrogen to make chemicals or fuels.

So far, all of these efforts have yet to produce any commercially competitive products. All of them add capital and operating costs, reduce overall system efficiency and will require subsidies for the foreseeable future. This inventions takes advantage of the fact that carbon dioxide is not the lowest energy state of carbon and that the chemical potential energy remaining in it can be recovered and used. Carbonate is the lowest energy state of carbon. The formation of carbonates from carbon dioxide is exothermic and thermodynamically favorable. It will accelerate, systematize, industrialize and commercialize these naturally occurring processes.

Key elements of the present invention, known as the Grimes' Processes, Electrochemical Reforming and Carbon Capture and Reuse, have been disclosed in the following US Patents, i) ECR—U.S. Pat. Nos. 8,419,922, and 8,318,130, and, ii) CCR—U.S. Pat. No. 8,828,216.

In U.S. Pat. Nos. 8,419,922, 8,318,130 and U.S. Patent Application 60/693,316, Grimes discloses several embodiments of the basic, liquid-phase electrochemical reforming process, which generates hydrogen from an aqueous mixture of methanol, water and electrolyte, including the effect of temperature, pH and catalyst on reaction rates and with details on both batch and continuous flow performance.

In U.S. Pat. No. 8,828,216 and U.S. Patent Application 60/693,316, Grimes discloses liquid-phase processes for the synthesis of fuels in a reactor containing an oxidizable reactant, water, an electrolyte and an electron transfer material. It also discloses an electrochemical cellular configuration where the energy generated and/or required is directed according to the thermodynamic demands of the half-cell reactions.

U.S. Pat. No. 7,947,239, discloses the basic methods and systems for capturing carbon dioxide from air using chemical processes, mineralization and solid or liquid sorbents that convert this acidic gas to a basic carbonate mineral.

This invention builds on this work by integrating subsystems that perform some or all of the functions described above, into existing power generation and industrial process plants to, i) capture input carbon prior to combustion or use, by carbonizing an aqueous solution of water and electrolyte, releasing hydrogen as a product, ii) capture post combustion, or use, carbon compounds by carbonizing an aqueous solution of water and electrolyte, iii) decarbonize the carbonized solution in an electrochemical cell that will evolve oxygen at one electrode and the desired hydrocarbon at the other, and, iv) manage all of the internal plant electrical and thermal flows to direct the heat and electricity needed to drive these processes to the appropriate reactors.

The integration of these multiple functions will insert an electrochemically active heat sink into the existing power generation or industrial process that will reduce or eliminate its need for external cooling water, an ever increasing problem worldwide.

This integration of these processes into conventional power plants, petrochemical plants, metal production, cement production, et. al, creates new income streams from the newly synthesized fuel and oxygen. These hydrocarbons can be exported and sold, or recycled for internal use, whichever is more economically advantageous.

This will increase the thermal efficiency of the integrated process plant, reduce, or eliminate, all carbon emissions from the primary process and by creating new revenue opportunities, or cost reductions, improve returns on invested capital. Most importantly, these newly created products will obviate the need for additional fossil energy, therefore reducing future CO₂ emissions. In this manner the invention directly addresses this global need.

### SUMMARY OF THE INVENTION

This invention integrates the Grimes process into a wide range of power generation, petrochemical and industrial process systems. In all cases, this integration will include the development of more capable thermal management subsystems as well as either pre or post combustion (or use) carbon capture, which is then converted into hydrocarbons and oxygen that can be subsequently exported or recycled into the process input. In most cases, these subsystems will be directly integrated into the production systems. However, they may also be added to external, indirect subsystems that provide heat, electricity, chemicals or other necessary inputs.

The first embodiments of this invention are the post combustion (or use) capture of carbon dioxide and its conversion into cost-competitive, drop-in, logistic-compatible, liquid fuels or chemicals (Grimes-Liquids or G-Fuels). Table 1 below shows CO₂ emissions from a number of target industries and the potential scale of production of zero-net carbon liquid fuels in comparison to total world liquid fuel consumption.

TABLE 1
Worldwide CCR Fuel Potential

| Source | tons CO2(e) | BOED G-Fuels | % of World Fuel Use |
|---|---|---|---|
| INDUSTRAIL | | | |
| Plastic | 1,800,000,000 | 25,410,677 | 27.86% |
| Steel | 3,459,500,000 | 48,837,910 | 53.54% |
| Aluminum | 928,000,000 | 13,100,616 | 14.36% |
| Cement | 2,200,000,000 | 31,057,494 | 34.05% |
| Paper | 252,000,000 | 3,557,495 | 3.90% |
| Total | 8,639,500,000 | 121,964,192 | 133.71% |
| POWER | | | |
| Coal Fired | 10,100,000,000 | 142,582,133 | 156.31% |
| Gas Fired | 3,072,100,000 | 43,368,967 | 47.55% |
| Oil Fired | 647,600,000 | 9,142,197 | 10.02% |
| Total | 13,819,700,000 | 195,093,297 | 213.88% |

*BEO = barrel of oil equivalent = 5.8 MMBTU = 6,119 MJ

This Table uses publicly available carbon dioxide emissions data and assumes that all capture is post combustion, or use. As is obvious from the numbers, the current emissions can become a major potential energy resource and, by recycling this carbon, can help substantially in restoring the balance between humans' energy needs and nature's ability to deal with the results.

The mass and energy inputs and output per ton of CO₂ captured and recycled are shown in detail in FIG. 34. This process requires the integration of three steps. The first two are chemical and the third is electrochemical. They are,

Step 1: Chemical capture of 50% of the desired CO₂ by converting hydroxide to carbonate and water.

3CO₂+6NaOH=>3Na₂CO₃+3H₂O (5)

Step 2: Chemical capture of the remaining 50% of the desired CO₂ by converting carbonate and water to bicarbonate.

3CO₂+3Na₂CO₃+3H₂O=>6NaHCO₃ (6)

Step 3: CCR electrochemical regeneration of the bicarbonate and water to hexane, hydroxide and oxygen. The hexane and oxygen can be sold and the hydroxide can be recycled to start the process again. The anodic half-cell reaction of this step is,

4NaOH=>2H₂O+O₂+4e− (7)

while the cathodic half-cell reaction is,

6NaHCO₃+26H₂O+38e⁻=>C₆H₁₄+44NaOH (8)

resulting in an overall reaction of

6NaHCO₃+7H₂O+28e⁻=>C₆H₁₄+6NaOH+9.50₂ (9)

This yields one mole of hexane for each six moles of carbon dioxide. Therefor a ton of CO₂, containing 22,722 moles, will produce 3,787 moles of hexane weighing 326.35 kg. with a volume of 137.92 gallons or 521 liters. Assuming a cost-competitive value of $0.50/liter for this hexane, which would drop into the worldwide market seamlessly, this would create a revenue opportunity of $260., which is more than enough to offset the initial capture cost of the CO₂.

A key element of these systems will be the development of an integrated thermal management subsystem that will recover the exothermic change in the Gibbs Free Energy occurring during the chemical capture steps and the maximum amount of waste heat available from all other subsystems. This will create a chemically and electrochemically active heat sink as a key element of all of the embodiments that will reduce or eliminate the need for external cooling water, an ever increasing problem worldwide.

A second range of embodiments of this invention will integrate the carbon capture prior to combustion or use. This will offer all of the benefits listed above but with the addition of the increase in overall thermal efficiency enabling a reduction in the amount of primary energy needed for the same amount of output.

In these cases. instead of a chemical capture step, the carbonaceous input will be fed into a low-temperature, liquid-phase Electrochemical Reformer (ECR) along with water and an electrolyte (acid, base of buffer).

CH4+2H₂O+NaOH=>4H₂+NaHCO₃ (10)

As formula 10 show, for this analysis an alkaline hydroxide is assumed and FIG. 35 shows the details of the total energy input (both ΔH and ΔG) as well as the hydrogen output. If 1,000 kg of methane is assumed as the primary energy input (1,395 m³ or 49,247 ft³), its heat of combustion would be 52.2 GJ or 49.5 MMBTU. By capturing low-grade waste heat (5.66 GJ or 5.4 MMBTU ΔH) and a small amount of electricity (175 kWh or 0.6 GJ ΔH), as well as recovering the change in Gibbs Free Energy (33.1 GJ or 31.3 MMBTU ΔG), the heat of combustion of the hydrogen produced is 71.5 GJ or 67.7 MMBTU.

This represents an increase in available energy of 36.8%, which, for a fixed amount of output, can reduce the amount of primary energy required by a proportional amount. Other benefits are the fact that combustion of hydrogen is substantially cleaner than any hydrocarbon and that the Carbon Intensity will also shrink proportionally.

The third series of embodiments of this invention describe the integration of these two processes within a single larger system. This will require additional waste heat and substantially more electricity to drive the processes. This electricity can be generated internally or imported from other external renewable sources. However, these subsystems can be either immediately adjacent to each other or spatially separated by great distances. In this latter case, the decarbonized electrolyte and Grimes-Liquids produced by the CCR can be shipped to remote locations where they can be fed into an ECR, that will produce hydrogen for local use with the carbonized electrolyte can be returned to the CCR to repeat the cycle. This offers a compelling alternative for efficiently transporting hydrogen as compared to compressed hydrogen, liquefied hydrogen and other Liquid Organic Hydrogen Carriers (LOHC), such as toluene and ammonia.

A final intriguing variant on this approach is using renewable electricity to drive the CCR. In this manner, this cycle can be used for bulk storage of intermittent renewable electricity.

The advantages of the current invention are:
Improving the efficiency of a process plant and power generation by polygeneration of electricity, heat, hydrocarbons and oxygen. These products, derived from the same fossil-fuel feedstock, thereby create more high value product to sell, increasing the gross income of the power plant and to more efficiently use the original fossil-fuel feedstock;
Capturing and using post-combustion carbon dioxide emissions and atmospheric carbon dioxide as reactant feedstock for this invention, thereby reducing or eliminating the carbon footprint of the emitting process plant and reducing that of the final products;
Capturing and using the pre-combustion carbon content of the primary fossil fuel input as well as atmospheric carbon dioxide as reactant feedstock for this invention, thereby reducing or eliminating the carbon footprint of the emitting process plant and reducing that of the final products;
Integrating internally generated plant waste heat along with available thermal energy from non fossil-fuel heat sources to supplement the thermal energy needed for driving the hydrocarbon synthesis reaction.
Integrating internally generated plant electrical energy along with non fossil-fuel electrical energy sources to supplement the electrical energy needed for driving the hydrocarbon synthesis reaction.
Enabling cost-competitive, long-distance transport of hydrogen.
And, enabling storage of surplus intermittent renewable electrical sources such as wind and solar

### BRIEF DESCRIPTION OF THE DRAWINGS

FIG. 1 shows the Ground State of carbon is not carbon dioxide (CO₂) but carbonate (CO₃). It also shows that a significant amount of recoverable energy is still available from CO₂.

FIG. 2 displays the energy content of various carbon based fuels and feedstocks on both the Carnot scale (left) and the Gibbs scale (right).

FIG. 3 shows a Grimes Free Energy process that is driven by both thermal energy and electrical energy. The necessary inputs are an oxidizable reactant A, a Reducible Reactant B, an ionically conductive electrolyte and some form of work. Under proper conditions these will produce the Desired Synthesis Product C and a By-Product D.

FIG. 4 is a Table showing a range of oxidizable reactants, reducible reactants, ionically conductive electrolytes, work, power and delta G inputs, electron transfer materials, desired synthesis products and by-products that can be processed by the redox reactor of FIG. 3. The lower portion of the table shows examples of how methane (CH₄) can be synthesized from an input of methanol (CH₃OH) and that the reverse synthesis of methanol can be synthesized from an input of methane.

FIG. 5 shows how the ECR integrates features from the two current commercial hydrogen production technologies Steam Methane Reforming (SMR>95%), a thermochemical process, and Electrolysis, an electrochemical process.

FIG. 6 shows examples of the flows of two electrochemical devices: the upper reactor is an electrochemical reformer (ECR) that accepts methanol and water and heat and/or electricity and outputs hydrogen gas as the desired product and carbon dioxide as the by-product, assuming thermal stripping or operating at electrolyte saturation. The lower reactor is a carbon capture and re-use (CCR) device that accepts carbon dioxide, water, heat and electricity and outputs methanol (CH₃OH) as the desired product and oxygen as the by-product.

FIG. 7 compares the efficiency and complexity of producing hydrogen via steam methane reforming (SMR) with hydrogen production via electrochemical reforming (ECR) of methanol.

FIG. 8 is a simplified diagram of a system that integrates an electrochemical reformer, which converts methanol, water and electrolyte to hydrogen and carbonized electrolyte with a fixed-bed, decarbonizing stripper that thermally regenerates the carbonized electrolyte using steam to remove the excess carbon as CO₂.

FIG. 9 is a simplified diagram of a system that integrates an electrochemical reformer, which converts methanol, water and electrolyte to hydrogen and carbonized electrolyte with a planar, electrochemical, decarbonizing stripper that uses electricity and heat to regenerate the carbonized electrolyte by producing hydrocarbons at one electrode and oxygen at the other with both by products being exported.

FIG. 10 is similar to the systems shown in FIGS. 9 and 8 except carbon dioxide is the input and the outputs are oxygen and hydrocarbons (CH₂)).

FIG. 11 shows the basic inputs and outputs of a fossil-fueled power plant.

FIG. 12 shows a more nearly complete method of calculating overall efficiency of electricity generation from one ton of coal that includes both the heat of combustion and Gibbs Free Energy.

FIG. 13 shows a simplified diagram of the 3G&S process for post combustion carbon capture and re-use to eliminate emissions and improve thermal efficiency. Fossil fuels can still be used to generate electricity without exhausting CO₂ to the atmosphere.

FIG. 14 shows a simplified diagram of a fossil-fueled power plant integrated with a post-combustion CO₂ capture carbonizer subsystem and a CCR decarbonizer producing hydrocarbons and oxygen for export.

FIG. 15 shows the efficiency calculation per ton of coal in a coal-fired power plant integrated with a post-combustion CO₂ capture carbonizer subsystem and a CCR decarbonizer producing hydrocarbons and oxygen for export.

FIG. 16 shows a simplified diagram of a fossil-fueled power plant integrated with a post-combustion CO₂ capture carbonizer subsystem and a CCR decarbonizer producing hydrocarbons and oxygen that are recycled to the plant input. The system also includes a steam stripper of CO₂ for the carbon from portion of the total fuel use that is still externally imported.

FIG. 17 shows the basic energy flows for a 400 MW natural gas-fired combined-cycle power plant (NGCC).

FIG. 18 shows the basic mass flows for a 400 MW natural gas-fired combined-cycle power plant (NGCC).

FIG. 19 shows the basic energy flows of a 400 MW NGCC power plant integrated with post-combustion CCR producing hexane for export.

FIG. 20 shows the basic mass flows of a 400 Mw NGCC power plant integrated with post-combustion CCR producing hexane for export and oxygen for internal consumption.

FIG. 21 shows the basic energy flows of a 400 MW NGCC power plant integrated with post-combustion CCR producing methane to be recycled for internal use.

FIG. 22 shows the basic mass flows of a 400 MW NGCC power plant integrated with post-combustion CCR producing methane and oxygen to be recycled for internal consumption.

FIG. 23 shows the basic energy flows of a 400 MW NGCC power plant integrated with pre-combustion carbon capture using an ECR, which produces hydrogen in sufficient quantities to supply the power plant. The carbonized electrolyte from the ECR is fed to a CCR producing methane to be recycled for internal use in the ECR.

FIG. 24 shows the basic mass flows of a 400 MW NGCC power plant integrated with pre-combustion carbon capture using an ECR, which produces hydrogen in sufficient quantities to supply the power plant. The carbonized electrolyte from the ECR is fed to a CCR producing methane to be recycled for internal use in the ECR with the oxygen produced fed into the power plant.

FIG. 25 shows the basic energy flows of a 400 MW NGCC power plant integrated with post-combustion CCR producing methanol for export and oxygen to be recycled for internal consumption.

FIG. 26 shows the basic mass flows of a 400 MW NGCC power plant integrated with post-combustion CCR producing methanol for export and oxygen to be recycled for internal consumption.

FIG. 27 shows a simplified diagram showing the material flows in a NGCC power plant with multi-pass ECR/CCR subsystems integrated to capture and reuse higher percentages of the initial fossil carbon than the single-pass systems shown above.

FIG. 28 compares the efficiency, yield and Carbon Intensity numbers of SMR hydrogen produced from liquefied natural gas versus ECR hydrogen made from remotely produced methanol.

FIG. 29 compares the efficiency, yield and Carbon Intensity numbers of SMR hydrogen produced from liquefied natural gas versus ECR hydrogen made from remotely produced biogas-methanol.

FIG. 30 shows the increase in yield created by using ECR hydrogen to generate electricity versus combusting the biogas directly.

FIG. 31 shows the increase in hydrogen delivered from a primary renewable electrical source by a physically separated CCR/ECR combination versus liquefied hydrogen.

FIG. 32 shows the increase in yield enabled by the same CCR/ECR configuration compared to ammonia as a Liquid Organic Hydrogen Carrier with both being driven by remote, renewable electrons.

FIG. 33 shows the potential energy density of an integrated ECR/CCR system being put on-board a fuel cell vehicle to provide hydrogen for transportation, assuming water recovery from the fuel cell

FIG. 34 shows the detailed energy input and output from one ton of carbon dioxide converted by a CCR into hexane.

FIG. 35 shows the detailed energy input and output from one ton of methane converted by a CCR into hydrogen.

### DETAILED DESCRIPTION OF THE INVENTION

The present invention describes the underlying technologies and methods of integrating them into novel configurations that will improve the thermal, carbon and economic efficiency of power generation and other industrial process plants. The key elements of the integrated systems are the ability to recover and reuse what is currently called “waste” heat (ΔH—enthalpy) and the more critical ability to recover and reuse the exothermic change in chemical potential (ΔG—Gibbs Free or Available Energy).

FIG. 1 shows both forms of energy recoverable from a carbon atom. The top step shows the 400 kJ per mole of ΔH available from the combustion of carbon to its final combustion by product, carbon dioxide. This is the generally accepted view of carbon utility and all current Carnot efficiency ratings are calculated by dividing the total recoverable energy out of a system (electricity, heat, etc.) by this figure. However, carbon dioxide is not the ground state of carbon, carbonate minerals are. The lower step shows the range of values of the chemical potential available, ΔG. This figure varies depending on what metal the carbon attaches itself to when it exothermically forms its carbonate mineral (a naturally occurring process called weathering). Carnot said that temperature is the ultimate limitation on efficiency but his thinking was incomplete in that he didn't include the effect of changes in chemical potential. This is the ultimate limit of efficiency, on which temperature depends.

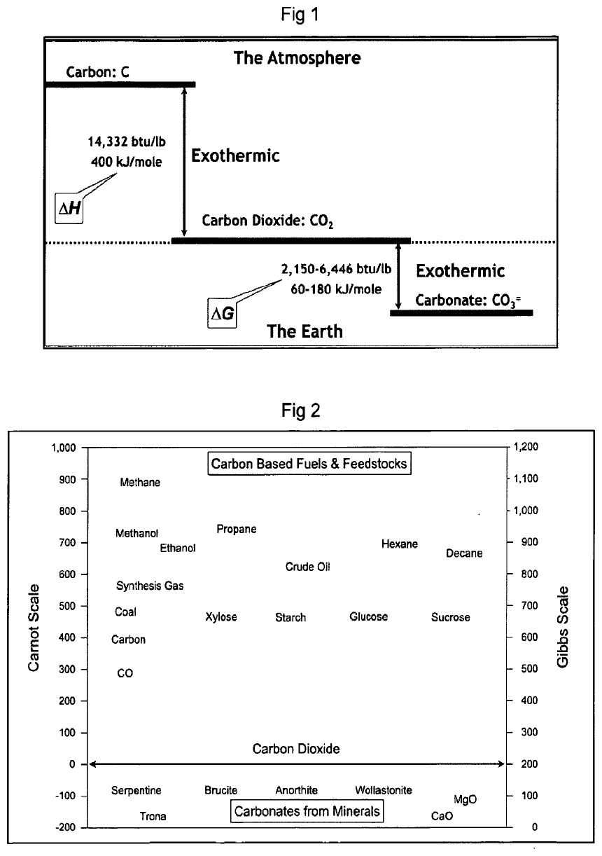

FIG. 2 shows the the energy content of a wide range of compounds with the ΔH Carnot scale on the left and the ΔG Gibbs scale on the right. Here CO₂ is at zero on the Carnot scale while it still has about 200 kJ available on the Gibbs scale. On the ΔG scale, even some minerals still have useful amounts of energy available (see sodium bicarbonate or Atka Seltzer).

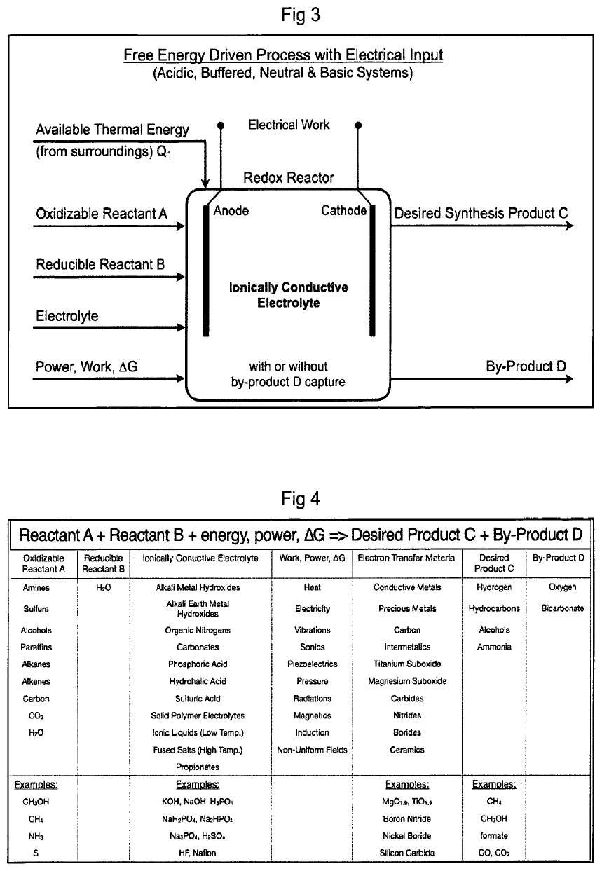

In order to benefit from this available energy a Free Energy Driven Process is needed. FIG. 3 shows a simplified schematic of such a process, where Oxidizable Reactant A and Reducible Reactant B are combined in a reactor with an Ionically Conductive Electrolyte, which can be acidic, neutral or basic, an electron transfer material, and some form of power or work is added (heat, electricity, or other form of ΔG). This will create Desired Synthesis Product C along with By-Product D, which can be captured in the solution or extracted from the reactor. FIG. 4 shows a matrix with a partial list of these reactants, electrolytes, forms of work, electron transfer materials, products and by-products. Desired systems would design the process to make by-product D salable as well as Product C. This would change the overall efficiency calculation from;

$$Efficiency \frac{Fuel Value Output}{Fuel Value Output}$$

to,

$$Efficiency \frac{Product C Fuel Value + By ‐ Product D Fuel Value}{Reactant A Value + Value of Work , Power \& Δ G} .$$

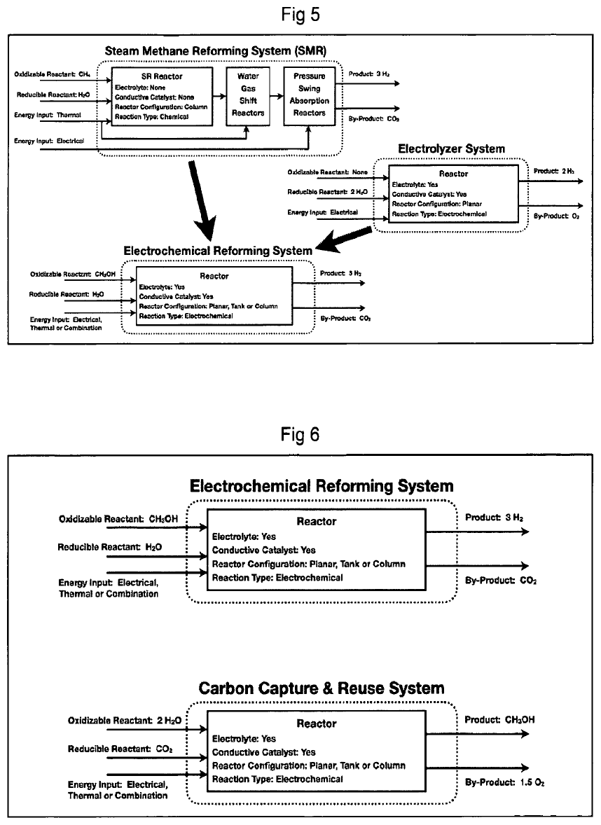

FIG. 5 shows an embodiment of this principle in a basic comparison of the Grimes liquid-phase ECR to the two commercially available methods of hydrogen generation used today, Steam Methane Reforming (SMR) and water electrolysis. The ECR combines the best features of each system thereby making up for the deficiencies in each. The SMR is missing an ionically conductive electrolyte and a conductive catalyst. The electrolyser is missing an oxidizable reactant. A comparison of the effect these omission is shown in the Table 2 below.

TABLE 2
Thermodynamic Comparison

| | | | ΔG | ΔH | ΔG | ΔH | | |
|---|---|---|---|---|---|---|---|---|
| | | temp | Kcal | Kcal | Kcal | Kcal | cell | system |
| PROCESS | fuel | ° C. | per mole fuel | per mole fuel | per mole H₂ | per mole H₂ | voltage | efficiency |
| CENTRALIZED NATURAL GAS | | | | | | | | |
| Steam Reforming | CH₄ | 850 | −38.77 | 40.40 | −9.69 | 10.10 | — | 85% |
| CENTRALIZED & DISTRIBUTED | | | | | | | | |
| Electrolysis² | H₂O + e⁻ | 75 | 54.76 | 67.94 | 54.76 | 67.94 | 1.95 | 65% |
| DISTRIBUTED NATURAL GAS | | | | | | | | |
| Steam Reforming¹ | CH₄ | 800 | −35.31 | 42.00 | −8.80 | 10.50 | — | 65% |
| HT Reforming¹ | CH₄ | 700 | −27.88 | 45.17 | −6.97 | 11.29 | — | 55% |
| Autothermal Reforming¹ | CH₄ | 850 | −24.07 | 46.74 | −6.02 | 11.69 | — | 55% |
| Partial Oxidation¹ | CH₄ | 600 | −93.04 | −11.36 | −23.26 | −2.84 | — | 50% |
| Electrochemical Reforming (t)³ | CH₄ | 400 | −1.89 | 29.95 | −0.47 | 7.49 | — | 87% |
| Electrochemical Reforming (e)² | CH₄ | 26 | 17.77 | 34.80 | 4.44 | 8.70 | 0.09 | 85% |
| DISTRIBUTED METHANOL | | | | | | | | |
| Steam Reforming¹ | CH₃OH | 280 | −18.03 | 25.95 | −6.01 | 8.65 | — | 65% |
| Electrochemical Reforming (t)³ | CH₃OH | 200 | −17.71 | 2.87 | −5.90 | 0.96 | — | 87% |
| Electrochemical Reforming (e)² | CH₃OH | 75 | −11.77 | 6.20 | −3.92 | 2.07 | 0.04 | 85% |
| CENTRALIZED & DISTRIBUTED | | | | | | | | |
| Carbonate ECR (t)³ | C | 200 | −19.68 | −2.51 | −9.64 | −1.28 | — | 87% |
| Carbonate ECR (e)² | C | 50 | −13.51 | 1.38 | −6.75 | 0.69 | 0.04 | 78% |

¹system efficiency calculations include heat input, gas separation and compression
²electrolysis and electrically driven ECR system efficiencies and CC energy penalty are based on the use of renewable electricity sources
³system efficiency is calculated assuming the use of internal heat

Here you can see that the lack of an oxidizable reactant increases the energy required to create a mole of hydrogen from water to 67.94 kJ. An SMR can deliver the same mole of hydrogen for an energy cost of 10.10 kJ but the temperature has risen from 75 to 800 C. An ECR can deliver the mole of hydrogen from methane thermally at half the temperature (400 C) and with a reduction in energy consumption to 7.49 kJ. If electricity is used to drive the ECR, the energy consumption will rise to 8.70 kJ but the temperature will drop to 25 C. However, since the process can be fed liquid as well as gaseous inputs, if methanol is used as the oxidizable reactant, the mole of hydrogen will cost only 0.96 kJ at a temperature of 200 C. This coupled with the fact that the ECR evolves hydrogen at a pressure slightly higher than the fuel/water/electrolyte mixture, which eliminates the need for gas-phase hydrogen compression, offers significant commercial advantage. FIG. 6 shows the basic diagram of a methanol ECR with a thermal CO₂ stripper regenerating the carbonized electrolyte and a Carbon Capture & Reuse (CCR) cell that is capturing CO₂ and producing methanol and oxygen as the product and by-product.

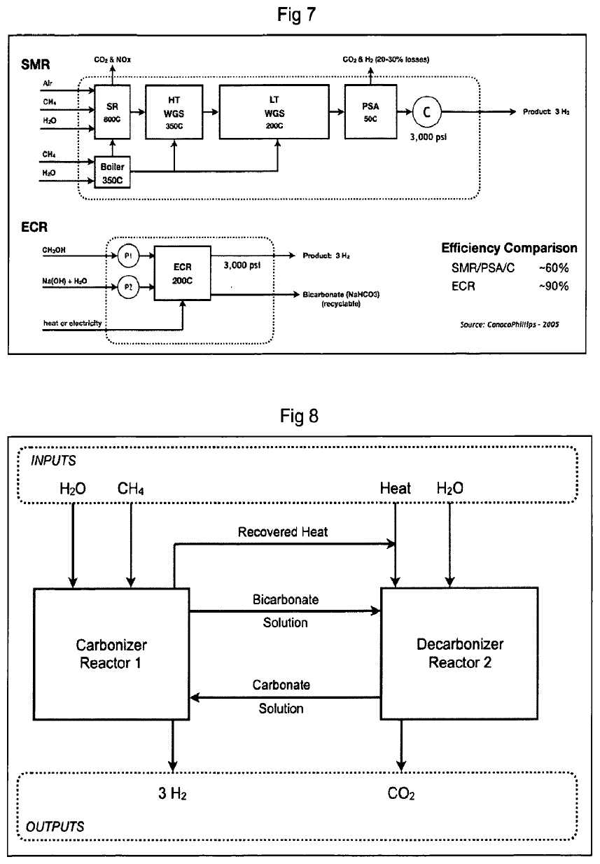

Another key advantage of the ECR is shown in FIG. 7, which compares the simplicity of the ECR to the complexity of an SMR. A typical SMR starts with a boiler that injects steam into the steam reforming reactor, which creates a syngas stream of hydrogen and carbon monoxide. This is fed into a high-temperature, water-gas shift reactor that converts a portion of the CO to CO₂. The output of this reaction is then fed into a low-temperature, water-gas shift reactor that completes this process. The output mixture of H₂ and CO₂, now called reformate, is then fed to a pressure swing absorption system that separates the hydrogen from the carbon dioxide. In this step about 20-30% of the product hydrogen is lost. Finally, the pure hydrogen is fed into a compressor for use, storage and/or transport.

By comparison, the ECR is a single reactor, operating at a lower temperature, that is fed the fuel/water/electrolyte mixture and evolves hydrogen at purities above 99%. This can be further cleaned at little expense and by compressing the input liquid to the desired output pressure, mechanical compression of the product gas is eliminated. The efficiency calculation was originally done by a major US oil company based on their experience with large-scale SMR and their funded lab work.

The flows of the initial embodiment of the ECR, called the Carbonizer, are shown in FIG. 8. This shows a continuous flow, heated, catalytic reactor that receives the input fuel and water and mixes it with an alkaline electrolyte. The input carbon will be converted to carbonate or bicarbonate, while gaseous hydrogen will be released.

CH₄+3H₂O+Na₂CO₃=>4H₂+2NaHCO₃ (11)

This step will reduce the pH of the electrolyte and at this point the carbon is effectively sequestered permanently. This carbonized electrolyte could be disposed of either in mines or in the ocean. Being basic, it would actually counteract the damaging acidification of the ocean that is being caused by Climate Change. However, since the cost of replacing the electrolyte is commercially unattractive, in this embodiment, a simple steam stripper, called the Decarbonizer, is used to regenerate the electrolyte back to its original condition and recycle back into the front end of the process.

2NaHCO₃+H₂O=>Na₂CO₃+CO₂ (12)

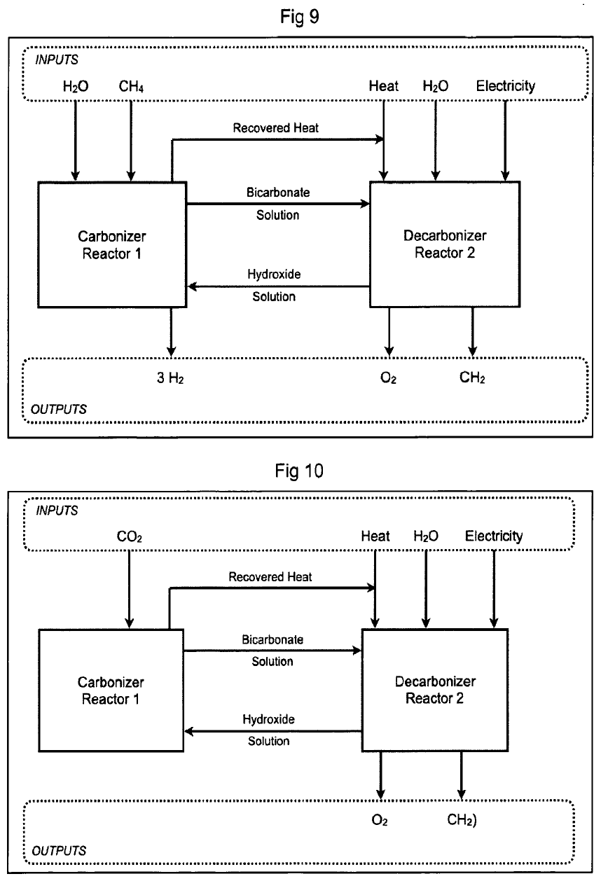

FIGS. 9 shows the flows of a methane fed ECR Carbonizer, producing hydrogen, mated with an electrically driven CCR Decarbonizer, that produces oxygen and hydrocarbons. (For this description CH₂ is shorthand of any hydrocarbon unless otherwise noted. The chain length of the output hydrocarbon would be determined by catalyst selection and operating parameters.). FIG. 10 shows a similar system but instead of fuel the ECR is fed CO₂. In this configuration, no hydrogen is produced. The Carbonizer acts as a capture system and feeds the carbonized electrolyte to the CCR to recycle the carbon as salable hydrocarbons and oxygen. Unlike many other carbon capture approaches, this will create additional income and increase overall system efficiency as opposed to being a financial and energy burden.

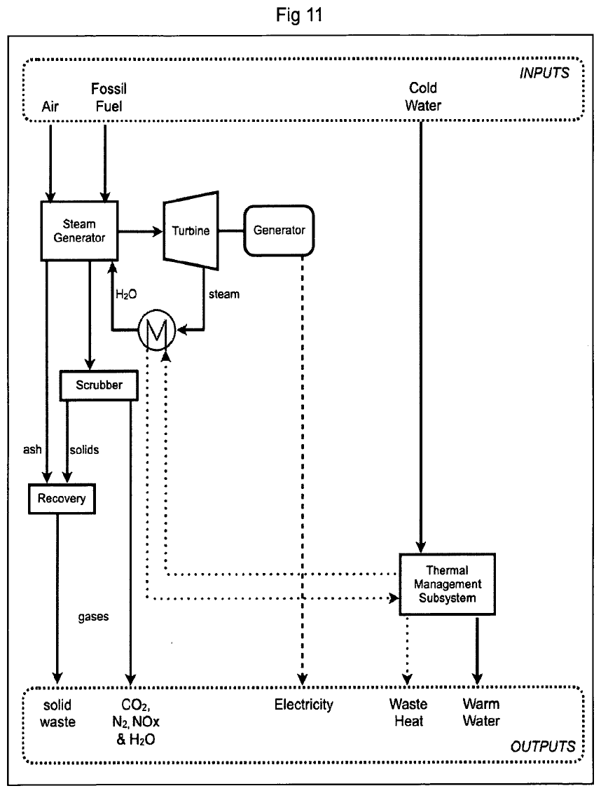

In order to properly understand the full effect of this invention, a clear understanding must be established regarding the definition of efficiency. FIG. 11 shows the typical configuration of a thermal power plant. Fuel and air are combusted in a boiler with the resultant steam being used to drive a turbine and generator. The boiler exhaust is scrubbed and vented to the atmosphere with ash collection and disposal. The spent steam is condensed with the water recycled and the waste heat is externally rejected. The efficiency of this plant is calculated by dividing the energy value of the electricity out by the energy value of the input fuel.

FIG. 12 shows an example of a more thorough calculation of this plant's efficiency based on the input of one ton of coal. The traditional calculation would divide the useful energy value of the electrical output (2,319 kWh(e)=7.91 MMBTU=8,345 MJ) by the heat of combustion (ΔH) of the coal input (20.61 MMBTU=21,744 MJ), yielding a thermal efficiency of 38.4%. However, this ignores the chemical potential (ΔH) of the 2,102 kg of CO₂ produced by the combustion process (12.33 MMBTU=13,008 MJ) giving the electrons produced a Carbon Intensity Number (CI#) of 252 grams CO₂/MJ. If this chemical potential is added to the calculation, while the output remains the same, the total input, ΔH plus ΔG, increases to 32.94 MMBTU or 34,752 MJ. This would reduce the overall efficiency of the plant to 24%.

Since CO₂ is the end product of combustion, it has always been ignored in efficiency calculation although CO₃, or carbonate, is the actual ground state. This oversight, and the assumptions that i) it was immaterial, and, ii) the atmosphere was an infinite sink, allowed an industrial civilization to be built with no concern for its effect. Unfortunately, it has crept up on the world in the form of Climate Change.

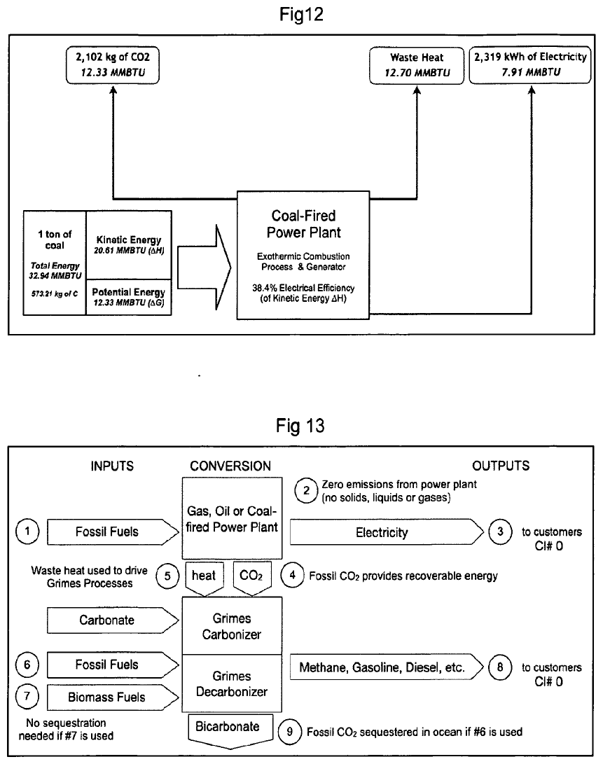

FIG. 13 shows a Grimes alternative to this old worldview. The top steps 1 through 5 show a typical fossil-fueled power plant but with the CO₂ and waste heat captured in an ECR Carbonizer. Since all carbon emissions are captured, the CI# of the electrical output is zero. The lower section shows two options. The more cost-efficient configuration would be the use of an ECR/CCR combination to make hydrocarbons for export (#8). In the second, the carbon could be sequestered as bicarbonate, which would require the addition of fresh carbonate electrolyte, at a cost. Path #6 shows the option of using additional fossil fuel input to create hydrogen that could be used to reduce the bicarbonate without electrical input, while Path #7 shows that biomass fuels (biogas, sugar, bio-methanol, etc.) can be used for this step and also drive the CI# of the hydrocarbon output to zero.

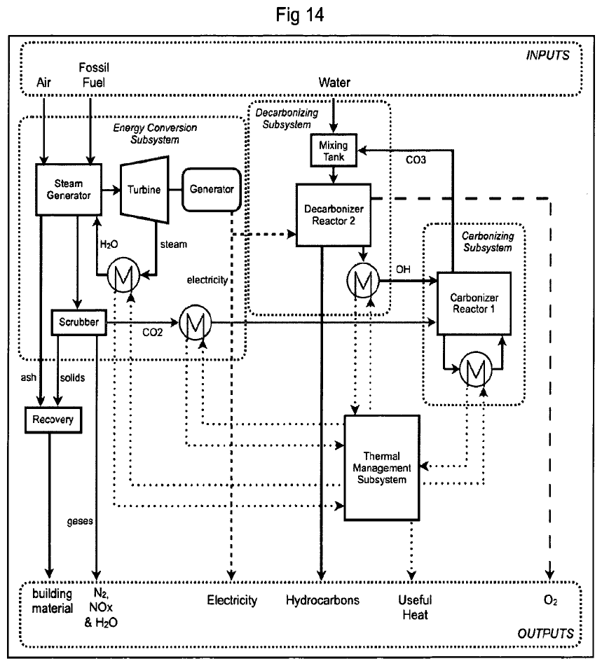

FIG. 14 shows the integration of a pre-combustion carbon capture embodiment of this invention into the same fossil-fueled power plant as shown in FIG. 11. It shows another key element of this invention, an Integrated Thermal Management Subsystem that captures the various temperatures of waste heat and matches them to the thermal requirements of the ECR Carbonizer and CCR Decarbonizer. For simplicity's sake, the simpler Power Management Subsystem is not shown.

In this embodiment, the first goal will be to design the system to recover and use all of the waste heat generated by the power plant. The second will be to minimize the electrical input required for the CCR Decarbonizing step. As FIG. 13 shows, additional hydrocarbon input can be fed directly into the ECR Carbonizing subsystem and the product hydrogen used to reduce the bicarbonate back to hydroxide. Since electricity is the primary plant output, minimal parasitic consumption is desirable. However, in this Figure the ECR Carbonizer is fed post-combustion CO₂ and both the product hydrocarbons and oxygen from the CCR Decarbonizer are exported.

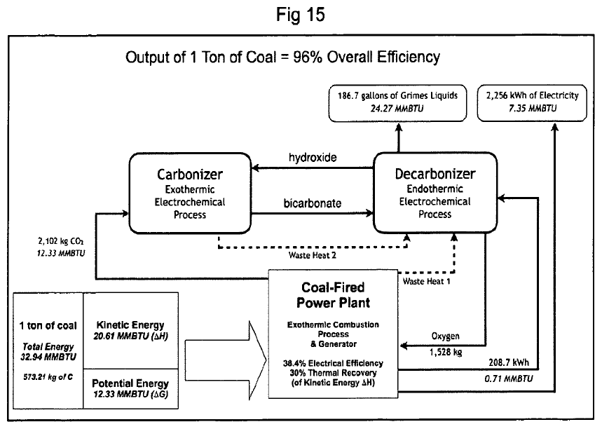

FIG. 15 shows the effect of this invention on the overall plant efficiency. The same total ΔH plus ΔG energy input (32.94 MMBTU or 34,752 MJ) produces only 93% of the prior electrical output, due to increased parasitic needs, but the invention adds an additional 24.27 MMBTU or 25,605 MJ of fuel to the output. This increases the total output to 31.62 MMBTU or 33,359 MJ, which yields an overall efficiency of 96%. If the hydrocarbons are exported for use elsewhere, the CI3 of the electricity is zero, while the CI# for the liquid fuel would be 82 grams CO₂/MJ as opposed to ˜100 for petroleum based diesel.

A final key feature of this invention is the fact that that oxygen it produces could be blended with input air to reduce nitrogen emissions and, depending on the fuel could enable 100% oxygen combustion eliminating them entirely. In the case of a fuel cell power plant, hydrogen/oxygen operation would also increase efficiency and longevity.

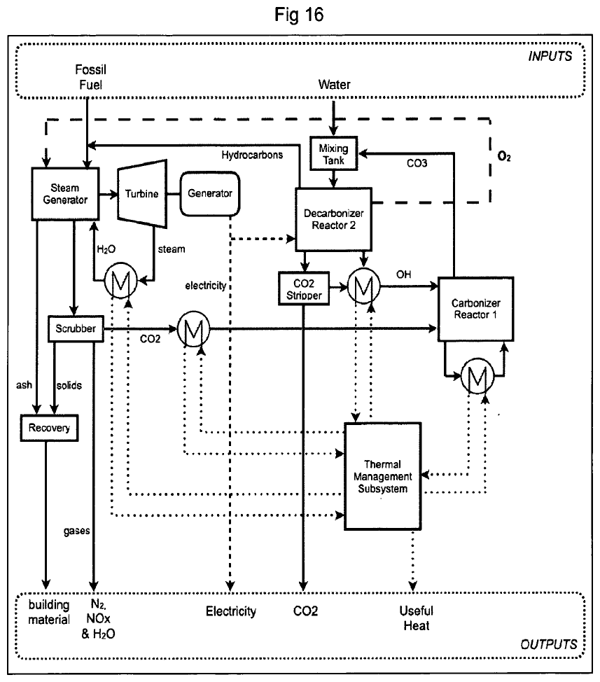

FIG. 16 shows another embodiment of the post-combustion configuration where the hydrocarbons and oxygen produced are recycled into the plant input. It incorporates a steam stripper to regenerate the carbonized electrolyte and therefore would produce CO₂. However this will reduce the need for imported energy and increase overall system efficiency while reducing the carbon intensity proportionally.

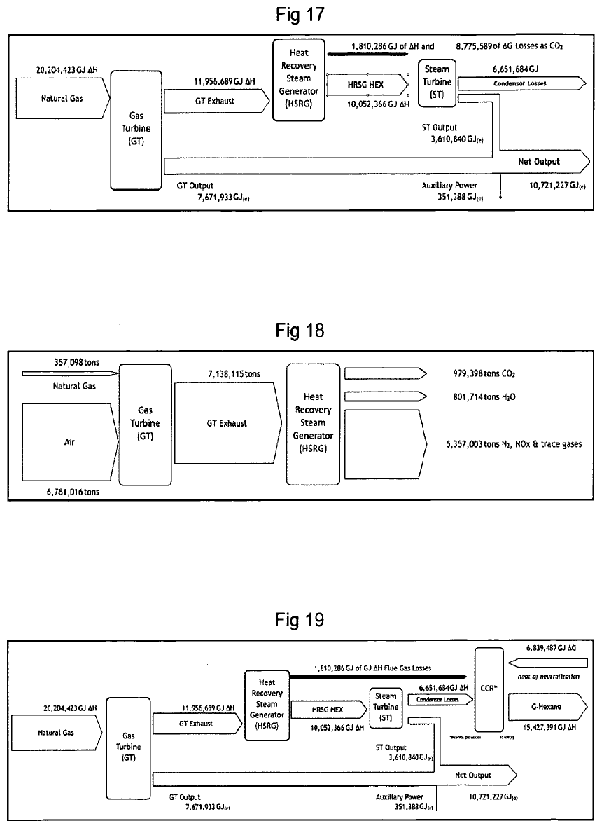

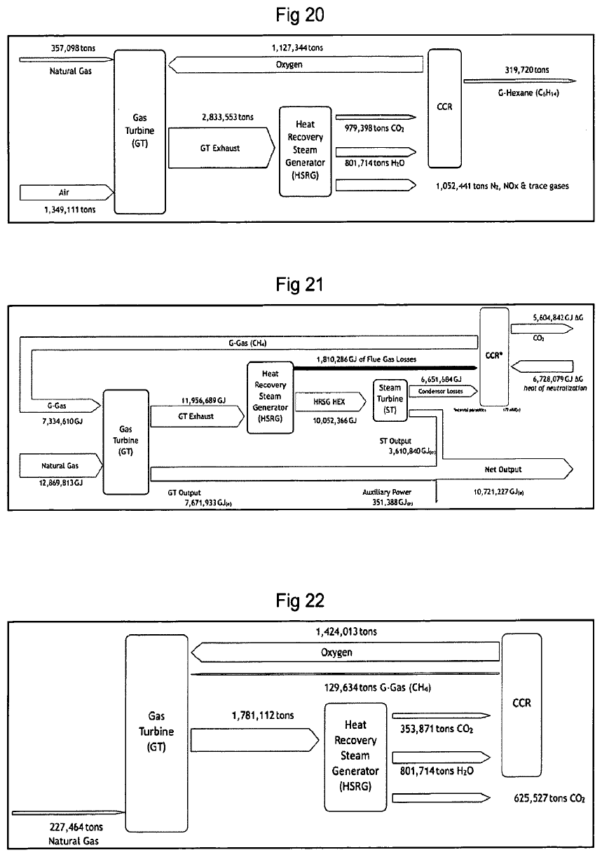

FIGS. 17 & 18 quantify the energy and mass flows for a typical 400 MW natural gas combined cycle (NGCC)power plant. Using ΔH calculations alone, the overall efficiency is 10,721,227GJ of electricity out divided by 20,204,423 GJ of natural gas in, or 53%. If the 5,604,842 GJ of ΔG is added to the input, the total grows to 25,809,265 GJ, which reduces the overall efficiency to 42%. Since the plant emits 979,398 tons of carbon dioxide per year, the CI# is 91 grams CO₂/MJ

FIGS. 19 & 20 quantify the effect of integrating the invention into the same plant with the CCR Decarbonizer producing hexane (C₆H₁₄) for export but with the oxygen recycled back into the plant input. Although this increases the salable output by 144% (15,427,391 GJ of hexane versus 10,721,227 GJ of electricity), to calculate overall efficiency, the total output of 26,148,618 GJ has to be divided by the total ΔH plus ΔG input of 27,043,890 GJ(20,204,403 GJ of ΔH from natural gas and 6,839,487 GJ of ΔG from the CCR). Therefore the theoretical system efficiency could increase to almost 97%. Looking at the history of electrolysis, an analogous process, the real-world performance should be significantly lower but still offer a major increase in efficiency over today's common practices.

FIGS. 21 & 22 show the energy and mass flows for the same plant with the post-combustion ECR/CCR combination producing methane and oxygen, both of which are recycled back into the plant input. The most notable effect of this embodiment is that the amount of natural gas needed per year shrinks from 20,204,423 GJ to 12,869,913 GJ, a reduction of 7,34,510 GJ, or 36%. This reduces the total ΔH plus ΔG input to 19,597,892 GJ(212,869,813 GJ of ΔH from natural gas and 6,728,079 GJ of ΔG from the CCR). Since the electrical output remains the same 10,721,227 GJ, the overall efficiency climbs to 55%.

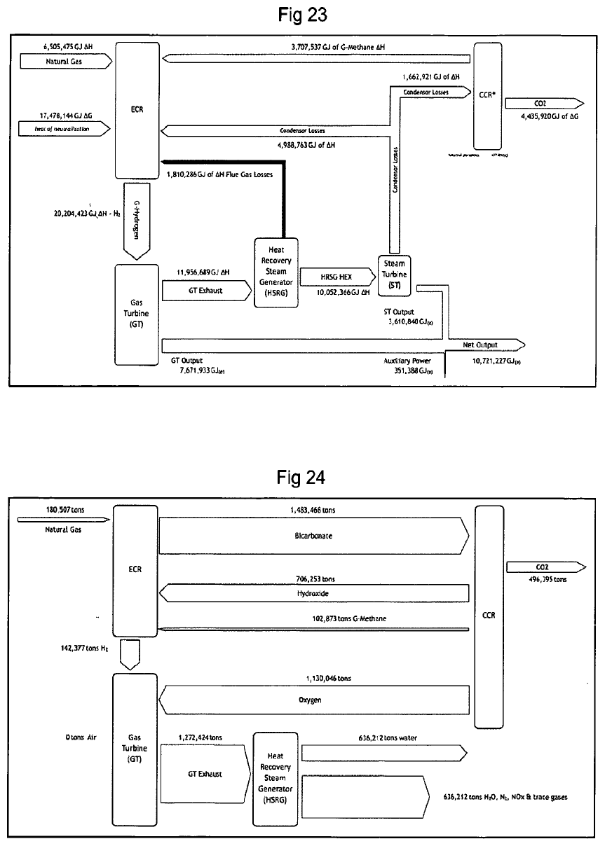

The energy and mass flows for a pre-combustion carbon capture embodiment of this invention are shown in FIGS. 23 & 24. In FIG. 23 6,505,475 ΔH GJ of input natural gas is fed directly into the ECR Carbonizer, which will produce the 20,204,423 ΔH GJ of hydrogen needed to deliver the 10,721,227 ΔH GJ of electricity from the combined cycle turbines. An additional 3,707,537 ΔH GJ of methane will be fed to the ECR/Carbonizer from the CCR Decarbonizer. The additional ΔG flows are the change of chemical potential in the ECR, which adds 17,478,144 ΔG GJ and the export of 496,395 tons of CO₂ (see FIG. 24) containing an additional 4,435,920 ΔG GJ of Available Energy. Therefore the total ΔH plus ΔG input equals 23,983,619 GJ. Divided into the combined ΔH plus ΔG outputs of 15,157,147 GJ this yield an overall system efficiency of 63%. Since air will still be needed nitrogen oxide emissions will be reduced and reduction in fossil natural gas input will reduce the CI# per MJ of electricity will drop to 46, a 49% reduction. In other embodiments of this invention, additional stages could be added in sequence to drive the CI# closer to zero.

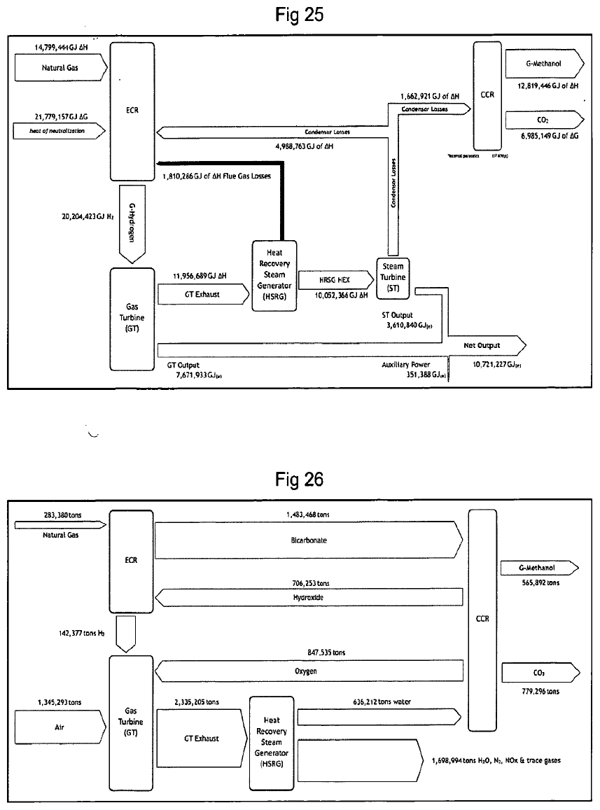

FIGS. 25 & 26 show the energy and mass flows for a similar size pre-combustion carbon capture embodiment configured for recycling of oxygen but export of CCR produced hydrocarbons, in this case methanol. In FIG. 25, the total ΔH plus ΔG input adds up to 36,598,601 GJ (14,799,444 GJ of ΔH from natural gas and 21,799,157 GJ of ΔG from the changes in chemical potential). Dividing this into the total ΔH plus ΔG output of 30,525,822 GJ (12,819,446 GJ of ΔH from the methanol, 10,721,227 GJ of ΔH from the electricity and 6,985,149 GJ of ΔG Available Energy left in the CO₂ emissions), yields an overall efficiency of 83%. FIG. 26 shows that this configuration will release 779,296 tons of CO₂. If all of these emissions are allocated to the exported methanol the CI# for that use would be 57, while the CI# for the electricity would drop to zero. If the methanol is used by the same entity that owns the power plant the average of the CI# for the total salable energy out would be 31. In both cases a significant reductions.

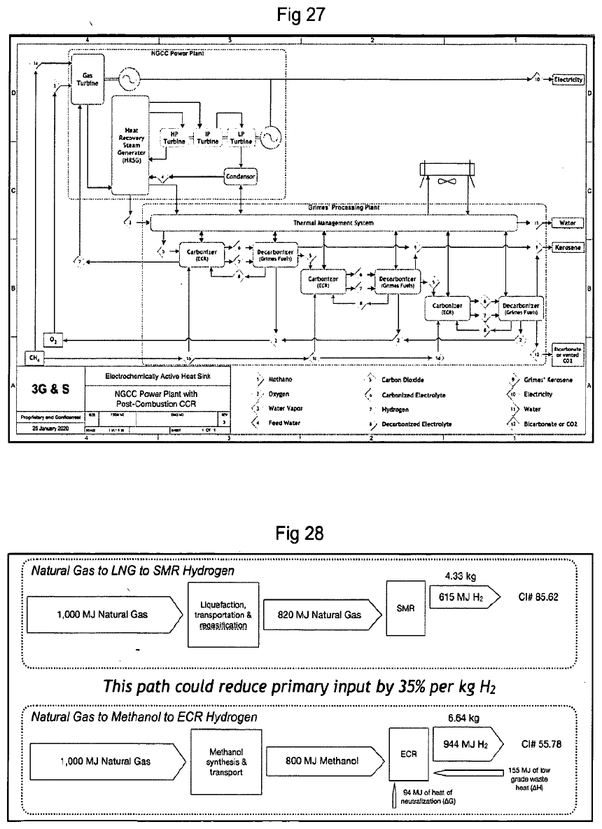

All of the previous Figures show systems with only a single-pass of capture, which doesn't capture or convert 100% of the input carbon. FIG. 27 shows a simplified diagram of a post-combustion, multi-pass configuration that can be used to reduce the net carbon emissions at a Natural Gas Combined Cycle Power Plant (NGCC). In this embodiment, the CCR Decarbonizer can use either electrons or hydrogen to reduce the carbonized electrolyte, which will require additional energy input to maintain constant electricity out. In this example, additional natural gas is used to produce hydrogen in post-combustion capture subsystems. Since the processes are easily scalable, as many multiple stages can be added as are needed to lower the net emissions as much as the customer wants. What final remnant remains can be easily disposed as solid carbonates, with the cost being spread across a much larger output. An example of this effect is shown in Table 3.

TABLE 3
Post-Combustion Multi-Pass Trend

| 400 MW NGCC Plant | Total Energy In | Electricity Out | Electric CI # | Fuel | Fuel CI # | Total Energy Out | Total CI # | Total Efficiency |
|---|---|---|---|---|---|---|---|---|
| configuration | GJ | GJ | g CO₂/MJ | BOED | g CO₂/MJ | GJ | g CO₂/MJ | % |
| today (bought fuel) | 35,980,205 | 10,721,227 | 106 | 7,479 | 74 | 24,919,431 | 88 | 69.26% |
| single-pass | 35,357,740 | 10,721,227 | 62 | 7,479 | 74 | 24,919,431 | 69 | 70.48% |
| double -pass | 45,847,987 | 10,721,227 | 40 | 13,088 | 74 | 35,568,085 | 54 | 77.58% |
| triple-pass | 56,463,686 | 10,721,227 | 18 | 18,764 | 74 | 46,344,084 | 61 | 82.08% |

This Table summarizes the model of a post-combustion system integrated with a 400 MW NGCC Power Plant. The top row shows, i) the total energy input, ii) electrical output and CI# for the power generated by such a plant, iii) the amount and CI# of the same amount of fuel that would be produced by a single-pass ECR/CCR system, 7,479 BOED (barrels of oil equivalent per day), iv) the total energy out and CI# and, v) the total efficiency of electricity and fuel production. The second row shows that a single-pass system would reduce the total energy input slightly and increase the total efficiency as well. However, the total CI# would drop from 88 to 69. The next row down shows the effect of a double pass embodiment, which increases the amount of energy in by about 30% but amount of fuel available to sell increases by almost 75%. Assuming the CI# of the fuel stays constant, the CI# of the electricity to less than 40% of the existing plant with the average down by 27%. Adding a third-pass increases the energy in but continues to reduce the electrical and overall CI# while increasing total efficiency as well. Additional passes could be added until the CI# drops as close to zero as desired.

The economic benefits of this invention also become clear. A 400 MW NGCC plant might gross $125/MWh or $1.2M/day. Wholesale diesel prices today are about $60/barrel. Therefore a single-pass system would add $0.45M, a double pass $0.79M/day and a triple-pass $1.13/day. Projected capital and operating costs show significantly increased net earnings from these integrated systems as well.

Another advantage of this invention is the competitive advantage it offers over other methods of generating hydrogen. FIG. 28 compares the net hydrogen output of an SMR, produced from pipeline natural gas, to ECR hydrogen made from methanol produced from the same natural gas. From an energy standpoint the ECR will consume 35% less natural gas per kg of hydrogen produced. However, this does not quantify the benefit of being able to store and transport the hydrogen as methanol and the fact that the carbon capture is inherent in the process , as opposed to being an add-on, with increased cost and decreased efficiency, as is the case of the SMR.

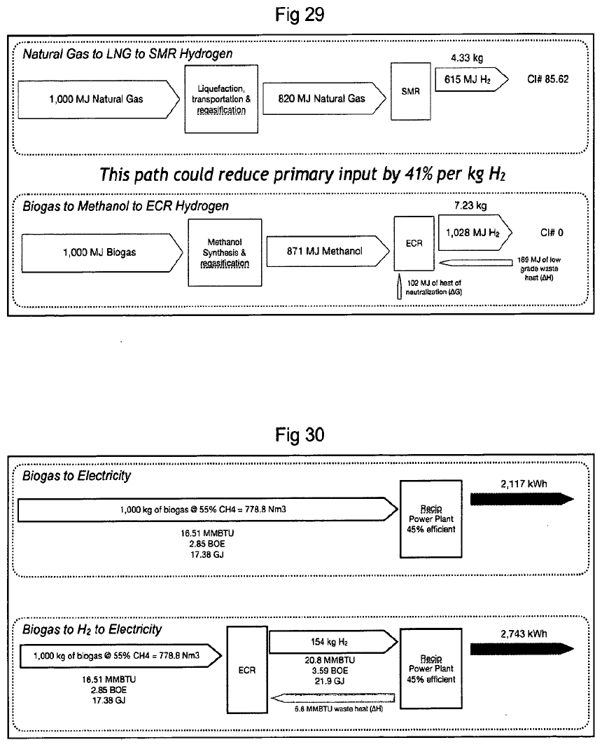

FIG. 29 shows the effect when the distance between the initial natural gas and hydrogen consumption is increased. The top section factors in the energy losses associated with liquefaction, transport and re-gasification. with these factors added, the net benefit increases to a 41% reduction in energy cost per kg of hydrogen produced.

FIG. 30 show another application where the ECR benefits is apparent. In this case, biogas is the primary energy input and electricity is the end product. If the biogas is used directly, the net output per metric ton in is 2,117 kWh. If the same amount of biogas is fed into an ECR and the hydrogen is used to produce electricity at the same efficiency, the net output will increase to 2,743 kWh. This represents a 30% increase in output per unit of energy in and the carbon is captured pre-combustion with no additional cost or energy penalty.

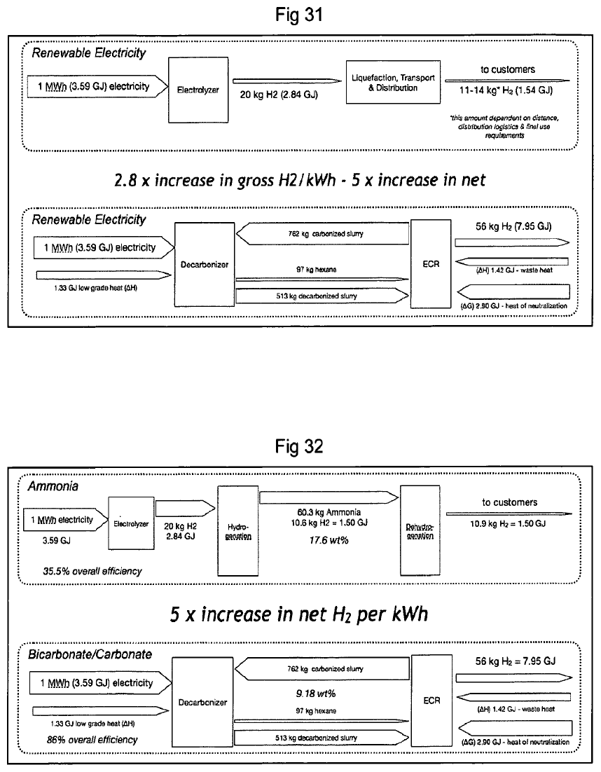

If you add the CCR to the ECR, the embodiment shown in FIG. 31 offers a competitive advantage over conventional transport of liquefied, electrolytic hydrogen. If we electrically drive a CCR Decarbonizer at a source of electricity (wind, solar, hydro, off-peak, etc.), this can be stored as a reduced electrolyte and hydrocarbon liquid. These two species can be stored for later use or transported and then recombined in an ECR to produce hydrogen at the point of need. The net effect, in comparison to conventional liquefied hydrogen transport is an increase to 500% of the total amount of available energy.

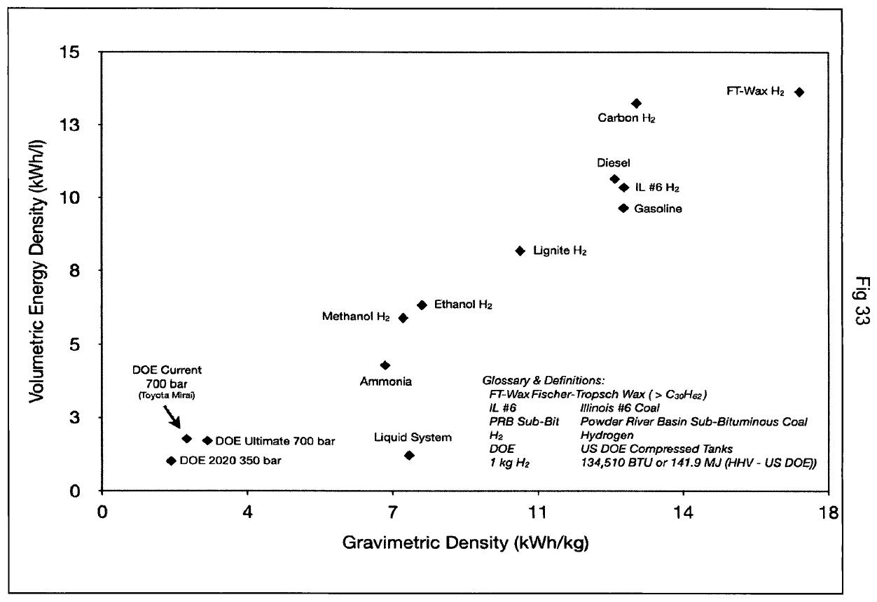

Similarly, FIG. 32 shows a comparison of the net hydrogen deliverable from 1 MWh of electricity using ammonia as the hydrogen carrier or the CCR/ECR combination. Again, the the total amount delivered is 5× the amount available from Ammonia.

These facts lead to an interesting conclusion shown in FIG. 33. Here the gravimetric and volumetric energy density of various on-board hydrogen storage systems are show. At the bottom left are the compressed tank systems currently used in vehicles and their targets for improvement. About the middle are methanol, ethanol and hydrogen from ethanol using an ECR. (In this analysis, the water needed for the reaction is recovered from the fuel cell using the hydrogen.). Obviously, all of the ECR hydrogen configuration are significantly better than compressed or liquid systems. Oddly enough, if wax (C₂₀H₄₂+) is used in the ECR, the overall energy density is higher than diesel. This, plus the fact that this can be ambient pressure and temperature addresses one of the major issues preventing hydrogen from becoming the dominant transport fuel.

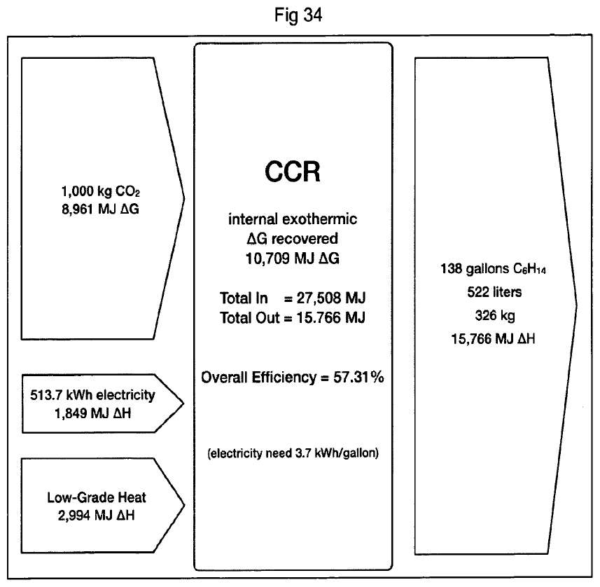

This ECR/CCR technology can also be added to systems at an energy and financial profit. FIG. 34 shows the fuel yield from one ton of capture CO₂. Based on the previously mentioned wholesale price of $60/BOED, this ton of carbon dioxide will create $200 of revenue. This will more than offset the capital and operating cost needed to install and operate such a system. These technologies make atmospheric carbon emissions an asset as opposed to a liability.

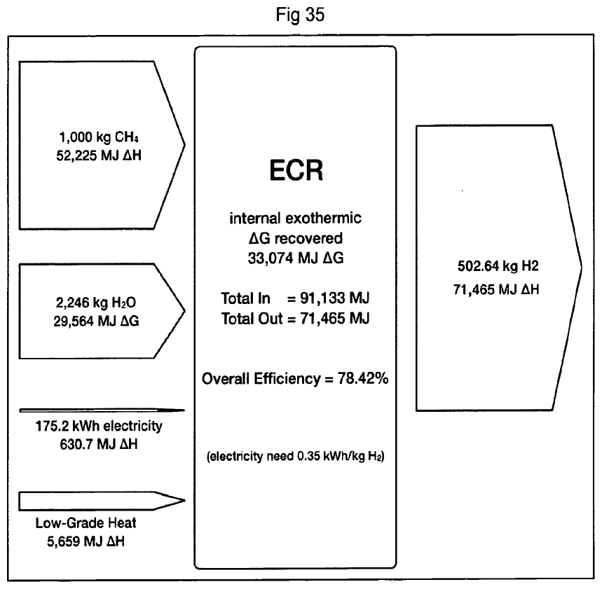

FIG. 35 shows a similar analysis of the useful output available form one ton of methane. Based on today's prices, that methane would cost about $150. At todays prices at a refinery, tis would sell for about $750. and at a fueling station, it would be worth over $2,000. This is evidence of the potential economic benefits this invention offers.

Although the examples given have related to power plants, the same principals can be applied to a wide range of other industrial process plants. Virtually all processes use electricity and/or heat, which generally creates CO₂ emissions, or the process itself uses carbon electrodes, as in the case of electrically driven steel and aluminum production, which are consumed and emitted as additional CO₂. This invention can capture and recycle these emissions for these and other process plants just as easily offering the same increases in thermal, carbon and economic efficiency.

All documents, including patents, described herein are incorporated by reference herein, including any priority documents and/or testing procedures. The principles, preferred embodiments, and modes of operation of the present invention have been described in the foregoing specification. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-50. (canceled)

51. A system integrating a fossil-fueled power plant with:
i) a post-combustion, carbon dioxide capture subsystem that carbonizes an acidic, basic or buffer, liquid electrolyte solution;
ii) a decarbonizing subsystem that regenerates the carbonized electrolyte solution;
iii) a thermal management subsystem that integrates the power plant waste heat and/or external heat sources with the thermal needs of the other subsystems;
iv) a power management subsystem that integrates and optimizes all internal electrical needs with external supplies and loads; and,
v) a control system to manage all of the above listed subsystems and respond to varying internal and external demands, interruptions and events.

52. The system according to claim 51, wherein the carbon dioxide capture subsystem captures carbon dioxide in one stage of carbonate to bicarbonate.

53. The system according to claim 51, wherein the carbon dioxide capture subsystem carbon captures carbon dioxide in two stages, the first stage capturing 50% in hydroxide to carbonate and the second capturing the remainder in the newly formed carbonate to bicarbonate.

54. The system according to claim 51, wherein the decarbonizing subsystem is a thermal decarbonization subsystem using steam to regenerate the bicarbonate to carbonate and carbon dioxide, which can be vented, collected, sold and/or sequestered.

55. The system according to claim 51, wherein the decarbonizing subsystem is an electrochemical cell using electrical and/or thermal input to strip the bicarbonate of oxygen at one electrode and hydrocarbons and/or oxygenated hydrocarbons at the other.

56. The system according to claim 51, wherein the decarbonizing subsystem is an electrochemical cell using electrical and/or thermal input to strip the bicarbonate of oxygen at one electrode and hydrocarbons and/or oxygenated hydrocarbons at the other.

57. A system integrating a fossil-fueled or supplied industrial process plant (i.e, steel, aluminum, cement, paper, fertilizer, petrochemical, hydrogen, etc.) with:
i) a post-combustion, or use, carbon dioxide capture subsystem that carbonizes an acidic, basic or buffer, liquid electrolyte solution;
ii) a decarbonizing subsystem that regenerates the carbonized electrolyte solution;
iii) a thermal management subsystem that integrates the power plant waste heat and/or external heat sources with the thermal needs of the other subsystems;
iv) a power management subsystem that integrates and optimizes all internal electrical needs with external supplies and loads; and,
v) a control system to manage all of the above listed subsystems and respond to varying internal and external demands, interruptions and events.

58. The system according to claim 57, wherein the carbon dioxide capture subsystem captures carbon dioxide in one stage of carbonate to bicarbonate.

59. The system according to claim 57, wherein the carbon dioxide capture subsystem captures carbon dioxide in two stages, the first stage capturing 50% in hydroxide to carbonate and the second capturing the remainder in the newly formed carbonate to bicarbonate.

60. The system according to claim 57, wherein the decarbonizing subsystem is a thermal decarbonization subsystem using steam to regenerate the bicarbonate to carbonate and carbon dioxide, which can be vented, collected, sold and/or sequestered.

61. The system according to claim 57, wherein the decarbonizing subsystem is an electrochemical cell using electrical and/or thermal input to strip the bicarbonate of oxygen at one electrode and hydrocarbons and/or oxygenated hydrocarbons at the other.

62. The system according to claim 57, wherein the decarbonizing subsystem is an electrochemical cell using electrical and/or thermal input to strip the bicarbonate of oxygen at one electrode and hydrocarbons and/or oxygenated hydrocarbons at the other.
